(19) United States
(12) Patent Application Publication
(10) Pub. No.: US 2013/0252221 A1
(43) Pub. Date: Sep. 26, 2013

(54) QUESTION GENERATION AND PRESENTATION

(71) Applicant: ALIBABA.COM LIMITED, George Town (KY)

(72) Inventors: Gregory Charles McNutt, Sunnyvale, CA (US); Michael Effle, Antioch, CA (US); Charles Bennett Smith, Livermore, CA (US); Boris Basevich, Sunnyvale, CA (US); Christina Liu, Burlingame, CA (US); Liujin Yu, Sunnyvale, CA (US); Victor Miagkikh, San Francisco, CA (US); Boomi Perumal, Fremont, CA (US); Rodney Andrew Resella, Pacifica, CA (US)

(73) Assignee: Alibaba.com Limited, George Town (KY)

(21) Appl. No.: 13/740,587

(22) Filed: Jan. 14, 2013

Related U.S. Application Data
(60) Provisional application No. 61/587,550, filed on Jan. 17, 2012.

(51) Int. Cl. G09B 7/00

(52) U.S. Cl. CPC G09B 7/00
USPC 434/350

(57) ABSTRACT

Presenting and generating questions are disclosed, including: presenting a first set of questions to a plurality of users; collecting a first set of answers pertaining to the first set of questions; generating a second set of questions pertaining to the first set of answers by the plurality of users; and determining influence scores corresponding to the plurality of users based at least in part on a second set of answers pertaining to the second set of questions.

### CROSS REFERENCE TO OTHER APPLICATIONS

This application claims priority to U.S. Provisional Patent Application No. 61/587,550 entitled ANSWERING QUESTIONS AND VALIDATING STATEMENTS USING SOCIAL CURRENCY filed Jan. 17, 2012 which is incorporated herein by reference for all purposes.

### BACKGROUND OF THE INVENTION

Users may complete surveys when they are solicited to do so but they may not be compensated for their time and effort. Furthermore, sometimes a survey may be designed to be long and complicated, whereas a solicited user has only a limited amount of time that he or she is willing to spend on completing the survey. As a result, the survey may not be completed by many of the solicited users, and neither those that administer the survey nor the solicited users may benefit from participating in the survey.

### BRIEF DESCRIPTION OF THE DRAWINGS

Various embodiments of the invention are disclosed in the following detailed description and the accompanying drawings.

FIG. 1 is a diagram showing an embodiment of a system for generating and presenting questions to users.

FIG. 2 is a diagram showing an example of a server.

FIG. 3 is a flow diagram showing an embodiment of a process for generating and presenting questions.

FIG. 4 is a flow diagram showing an embodiment of a process for generating questions.

FIG. 5 is a flow diagram showing an embodiment of a process for selecting a question to present to a user.

FIG. 6 is a flow diagram showing an embodiment of a process for allocating social currency for a submission of an answer to a question.

FIG. 7 is a flow diagram showing an embodiment of a process for decaying influence scores over time.

FIG. 8 is a diagram showing an example of an authentication user interface associated with the question generation and presentation service.

FIG. 9 is a diagram showing an example of a question type selection user interface associated with the question generation and presentation service.

FIG. 10 is a diagram showing an example of a user profile user interface associated with the question generation and presentation service.

FIG. 11 is a diagram showing an example of a user interface associated with a presentation of a seed question.

FIG. 12 is a diagram showing an example of a user interface associated with a presentation of a secondary question.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Embodiments of question generation and presentation are described herein. A set of seed questions is generated. For example, a seed question may solicit for a user's opinion related to one or more products. The seed questions are presented to users. For example, a user may use a software application associated with answering questions and choose to answer as many seed questions that the user has time for at the moment. The answers to the seed questions are collected and a set of secondary questions are generated based on the users' submitted answers to the seed questions. For example, if an answer to a seed question included a first user's opinion, then the secondary question generated based on that answer may inquire a second user whether he or she agrees with the first user's opinion. The set of secondary questions are presented to users. For example, a mix of seed questions and secondary questions may be presented to the user when the user opens the software application associated with answering questions. The answers to the set of secondary questions are collected and influence scores are determined for the users based on the collected answers to the secondary questions. In some embodiments, an influence score of a user reflects the user's influence on a community of users. In some embodiments, a user may be associated with multiple influence scores, where each influence score is associated with the user's influence in a particular category of questions. In some embodiments, the answers to the set of secondary answers are iteratively used to generate more secondary questions. In some embodiments, units of social currency, which comprise virtual credits, are awarded to users based on their submission of answers (e.g., level of participation in answering questions). In some embodiments, users with greater influence (e.g., a higher influence score) may be given more social currency for either answering a question or having an opinion that is included in a secondary question that is answered by another user. In some embodiments, units of social currency earned by a user may be used by the user to perform certain activities that cost the expenditure of social currency.

Through the generation and presentation of questions, credits (e.g., social currency units) may be awarded for a user's participation in answers questions. Furthermore, more credit may be given to users with relatively higher influence. Users are therefore encouraged to answer more questions to increase their influence in the community and earn more credits.

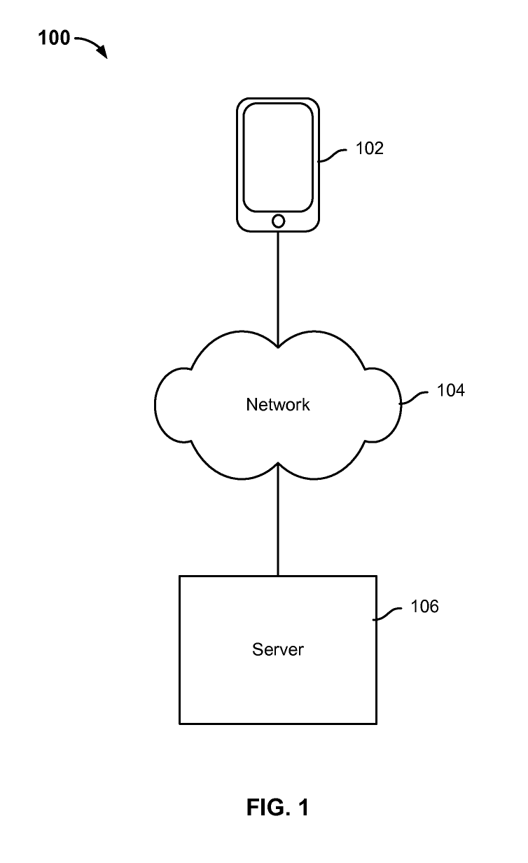

FIG. 1 is a diagram showing an embodiment of a system for generating and presenting questions to users. In the example, system 100 includes device 102, network 104, and server 106. Network 104 includes high-speed data networks and/or telecommunications networks.

Device 102 communicates with server 106 over network 104. While device 102 is shown to be a smartphone device, other examples of device 102 may include a desktop computer, a laptop computer, a mobile device, a tablet device, or any other type of computing device. A user using device 102 may access a question generation and presentation service either by using a dedicated application (e.g., a smartphone application) or by using a web browser to access a particular website associated with the question generation and presentation service. The question generation and presentation service may be provided at least in part by server 106. For example, a user who uses the question generation and presentation service for the first time may perform registration with the service. Then, when the user has some spare time, he may access the question generation and presentation service using a mobile device and answer as many questions as he has time for. This way, the user may conveniently use his leisure time to submit some of his opinions in the form of answers to presented questions and even earn social currency units in the virtual community of the question generation and presentation service.

Server 106 is configured to provide, at least in part, the question generation and presentation service. In some embodiments, the question generation and presentation service may be implemented as a website and/or as an application. In response to a user making a selection associated with receiving a question, server 106 is configured to select a question to present to the user at a device such as device 102. In some embodiments, server 106 is configured to present a question to the user based at least in part on an influence score associated with the user. For example, the influence score may apply across all categories of questions or may be associated with a particular category of questions. In some embodiments, the question may comprise a seed question or a secondary question. As used herein, a seed question is not generated based on a user's submitted answer to another question. As used herein, a secondary question is based on a user's submitted answer to another question (e.g., another question such as a seed question or another secondary question). Server 106 is configured to receive an answer submitted by the user to the presented question. In some embodiments, if the presented question comprised a secondary question, then the received answer may be used to generate another secondary question to be presented to other users. In some embodiments, in the event the answered question comprised a secondary question, server 106 is configured to determine an increase or decrease to the influence score of at least one user included in the secondary question. For example, the secondary question may inquire for agreement with a first person's opinion or a second person's opinion. If the answer submitted by the user agreed with the first person's opinion, then the first person (user) may receive an increase in his influence score while the second person (user) may receive a decrease in his influence score. In some embodiments, server 106 is configured to generate a unit of social currency for the submission of an answer to either a seed question or a secondary question. In some embodiments, server 106 is configured to allocate a first portion of the social currency unit to the user who answered the question and a second portion of the social currency unit to a user included in the question (e.g., the user whose opinion the answering user agreed with).

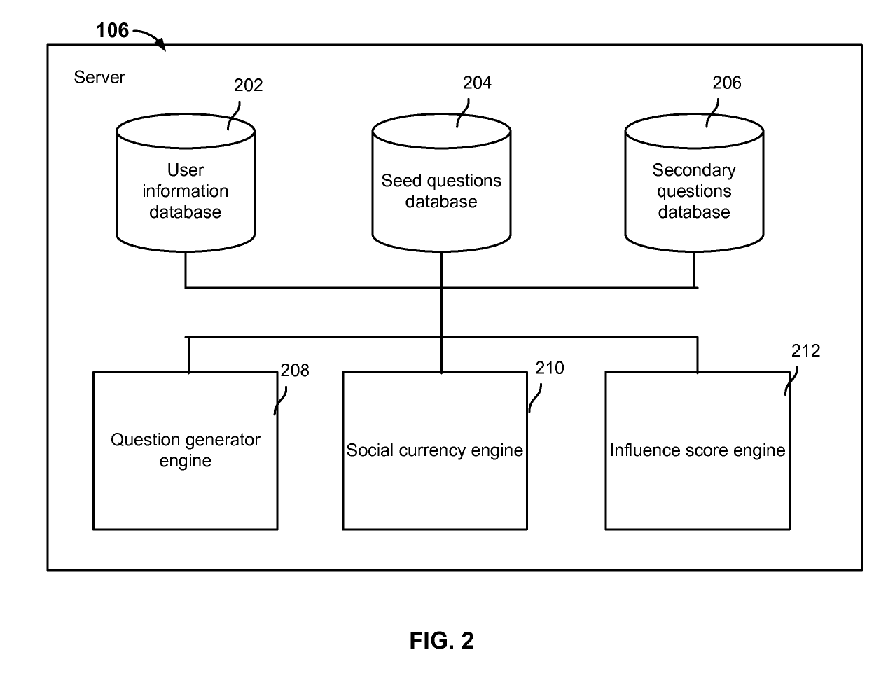

FIG. 2 is a diagram showing an example of a server. In some embodiments, server 106 of system 100 of FIG. 1 may be implemented using the example shown in FIG. 2. In actual implementation, server 106 may include additional and/or different components than those shown in the example. In the example, the server includes user information database 202, seed questions database 204, secondary questions database 206, question generator engine 208, social currency engine 210, and influence score engine 212. Each of user information database 202, seed questions database 204, and secondary questions database 206 may be implemented using one or more databases. Each of question generator engine 208, social currency engine 210, and influence score engine 212 may be implemented using software and/or hardware.

User information database 202 is configured to store information associated with each user that is registered with the question generation and presentation service. User information database 202 is configured to store each user's submitted answers for seed questions and secondary questions that the user has been presented with. In some embodiments, questions and/or user submitted answers may be stored in a graph database such as, for example, Neo4j. In some embodiments, the graph database and/or additional logic may be used to keep track of which questions have already been asked of which users and which questions have not been asked of which users. User information database 202 is configured to store each user's accumulated social currency. In some embodiments, each time a user answers a question, the user is awarded at least a portion of a unit of social currency. User information database 202 is configured to store data associated with the number of question generation and presentation service recognized relationships (e.g., friendships) each user has with other users of the service. User information database 202 is configured to store data associated with each user's current influence score(s). In some embodiments, each user is associated with an overall influence score that applies across all categories of questions. In some embodiments, each user is associated with multiple influence scores, where each influence score is associated with a different category of questions. One purpose to maintaining multiple influence scores is to reflect that notion that a user may be influential (an expert) in only some categories but not necessarily every category. Thus, the magnitude of a user's influence score with respect to a particular category of questions reflects the user's influence in that particular category. In some embodiments, when a first user's answer (e.g., opinion) is included in a secondary question that is answered by a second user, the first user's influence score may be increased or reduced depending on the answer submitted by the second user. As will be described below, in some embodiments, a user's influence score automatically decays over time (to reflect the notion that a user's influence may grow and ebb over time as trends change).

In some embodiments, the user submitted answers to seed questions and/or secondary questions stored in user information database 202 may be analyzed periodically. For example, if the questions are related to e-commerce, the answers may comprise user's opinions on different products and/or agreements or disagreements with other user's opinion on different products. Therefore, such answers may be analyzed to discover trends, consensuses, crowd-sourced answers, and/or convergence of agreement regarding the subject matter of the questions.

Seed questions database 204 is configured to store seed questions. As mentioned above, seed questions are not based on user submitted answers to other questions. In some embodiments, seed questions may be received from questions generator engine 208. In some embodiments, questions generator engine 208 may receive inputs of manually generated seed questions. In some embodiments, questions generator engine 208 may automatically generate seed questions based on configured rules. In some embodiments, at least some seed questions stored in seed questions database 204 is stored with data associated with one or more question categories. A seed question may comprise a single survey question, for example. In some embodiments, a seed question may be related to e-commerce. In one example, an e-commerce seed question may ask the user to select one product/brand among several products/brands that the user prefers the most. In another example, an e-commerce seed question may ask the user to select one among multiple descriptions that best describes a particular product. In yet another example, an e-commerce seed question may ask the user to express an opinion for a particular product/brand. For example, categories of e-commerce related questions may include clothing, jewelry, electronics, sporting equipment, books, and shoes. For example, an advertiser may manually generate seed questions associated with a particular brand to conduct market research from the users of the question generation and presentation service.

Secondary questions database 206 is configured to store secondary questions. As mentioned above, secondary questions are based on user submitted answers to other questions (either seed or secondary questions). In some embodiments, secondary questions may be received from questions generator engine 208. In some embodiments, questions generator engine 208 may receive inputs of manually generated secondary questions. In some embodiments, questions generator engine 208 may automatically generate secondary questions based on configured rules and user submitted answers to seed questions and other secondary questions. In some embodiments, at least some secondary questions stored in secondary questions database 206 is stored with data associated with one or more question categories. A secondary question may comprise a question related to another user's opinion on a subject matter, for example. In some embodiments, a secondary question may be related to e-commerce. For example, a secondary question may ask a first user whether he or she agrees with a second user's opinion on a particular brand, where this second user's opinion was an answer submitted by the second user to another question.

In some embodiments, question generator engine 208 is configured to select seed questions and/or secondary questions to present to users. In some embodiments, question generator engine 208 is configured to track which questions have already been presented to which users. In some embodiments, question generator engine 208 is configured to determine a question to ask a user in response to an indication that the user is available to answer a question. In some embodiments, question generator engine 208 is configured to determine a question for a user based at least in part on a user's influence score (e.g., the user's overall influence score or the user's influence score with respect to a specific category of questions).

Social currency engine 210 is configured to award social currency to users of the question generation and presentation service. In some embodiments, social currency engine 210 is configured to generate a unit of social currency in response to a user submitting an answer to either a seed question or a secondary question. In some embodiments, in response to a user submission of an answer to a seed question, social currency engine 210 is configured to award the entire unit of social currency to the user. In some embodiments, in response to a user submission of an answer to a secondary question, social currency engine 210 is configured to award a portion of the unit of social currency to the user who answered the question and another portion of the unit of social currency to another user (e.g., whose opinion) was included in the answered question. In some embodiments, social currency engine 210 is configured to allocate the portion of the unit of social currency to the user who answered the question based on that user's influence score and the other portion of the unit of social currency to the other user (e.g., whose opinion) was included in the answered question based on that user's influence score.

In some embodiments, social currency engine 210 is configured to receive an indication that a particular user paid money to receive an amount of social currency units. Put another way, in some embodiments, users may pay real world currency in exchange for virtual social currency. In this case, social currency engine 210 is configured to award the amount of social currency units to the user based on an amount of real world money paid by the user. In some embodiments, social currency engine 210 is configured to receive selections associated with a user wanting to trade in his or her accumulated social currency units into physical or virtual prizes and/or to perform in-service activities that cost social currency units. For example, an in-service activity that costs social currency units is establishing a new in-service relationship (e.g., friendship) with another user. In some embodiments, social currency engine 210 is configured to receive a selection that user desires to trade social currency units for an increase in an influence score associated with the user. Put another way, in some embodiments, a user may trade in social currency units for an increase in his or her influence score.

Influence score engine 212 is configured to determine modifications to users' influence scores. In some embodiments, influence score engine 212 is determined to increase or decrease the influence score of a user whose opinion (that was previously submitted as an answer to a question) was included in a recently answered secondary question. For example, if the first user's opinion was agreed with by a second user who submitted the answer to the secondary question, the first user's influence score is increased. However, if the first user's opinion was disagreed with by the second user who submitted the answer to the secondary question, then the first user's influence score is decreased. In some embodiments, influence score engine 212 is configured to decay each user's influence score(s) over time (e.g., periodically). Put another way, a user's influence score will automatically decrease over time. The decay in influence scores is to reflect the notion that a user's influence (in a particular category) may wane over time if the user does not keep performing activities to increase the user's influence score. In some embodiments, a user will be asked more questions in categories for which the user's has higher influence scores.

In some embodiments, users with the highest influence scores may be identified for special activities and/or to be treated differently from users who are not associated with the highest influence scores. For example, periodically, users with the highest influence scores (highly influential users) may be identified for each category and be eligible for special promotional activities. Examples of promotional activities may include a direct award of a certain amount of social currency units and receipt of seed questions submitted by advertisers aimed especially for influential users. Furthermore, highly influential users may be included in a leader board of influence scores that is available for other users to view.

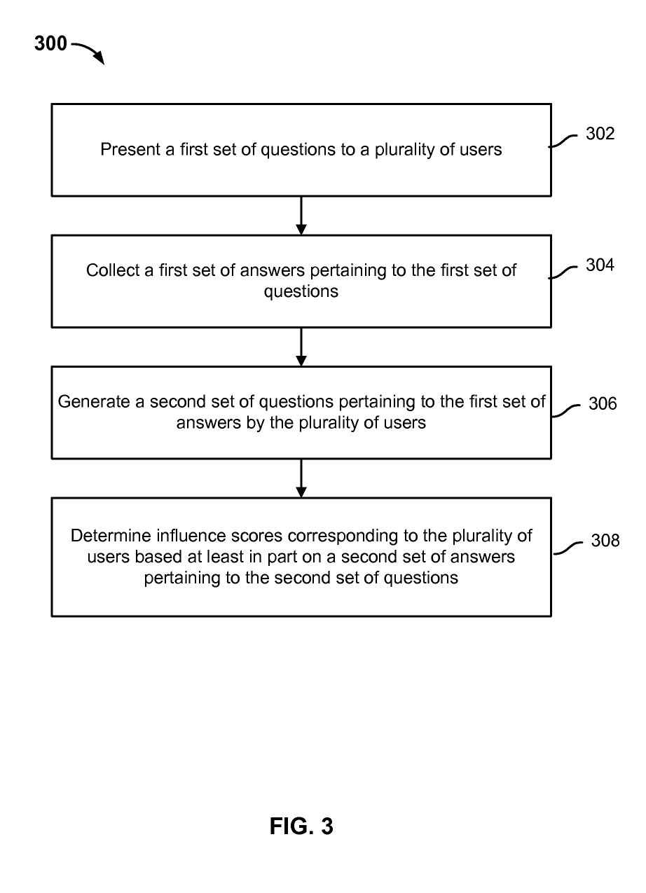

FIG. 3 is a flow diagram showing an embodiment of a process for generating and presenting questions. In some embodiments, process 300 is implemented at system 100.

At 302, a first set of questions is presented to a plurality of users. In some embodiments, the first set of questions may comprise seed questions that are presented to users that access the question generation and presentation service.

At 304, a first set of questions pertaining to the first set of questions is collected. The answers submitted by the users to the seed questions are collected and stored. For example, a seed question asks a user for the user's opinion on a particular subject matter. In some embodiments, the seed questions may be related to e-commerce. The following are different examples of seed questions:

Is this first product the same as the second product? Answer choices: a) Agree b) Disagree c) Skip. An image accompanying the question may show each of the two products.

This product belongs in Category A. Answer choices: a) Agree b) Disagree c) Skip. An image accompanying the question may show the product as well as a link to a description of the category.

This product has Attribute B. Answer choices: a) Agree b) Disagree c) Skip. An image accompanying the question may show the product as well as a link to a description of the attribute.

What category does this product belong to? Answer choices: a) Category A b) Category B c) Category C. An image accompanying the question may show the product as well a description of each candidate category.

What color is this? Answer choices: a) Color 1 b) Color 2 c) Color 3. An image accompanying the question may show the color as well the name of each color candidate.

What color is this product? The answer is to be written in by the user. An image accompanying the question may show the product.

What kind of product is this? The answer is to be written in by the user. An image accompanying the question may show the product.

At 306, a second set of questions pertaining to the first set of answers by the plurality of users is generated. In some embodiments, the second set of questions may comprise secondary questions that are generated based at least in part on the answers submitted for the first set of seed questions. For example, a secondary question asks a first user whether the first user agrees with a second user's opinion, where this second user's opinion was previously submitted as an answer to a seed question.

At 308, influence scores corresponding to the plurality of users based at least in part on the second set of answers pertaining to the second set of questions is determined. The influence scores of the users whose answers to the first set of seed questions that were included in the secondary questions to which answers were collected are modified. In some embodiments, the influence score of a user may either be increased or decreased based on the answer submitted to the secondary question. For example, if the user's opinion is agreed with by another user who submitted the answer to the secondary question, the user's influence score is increased.

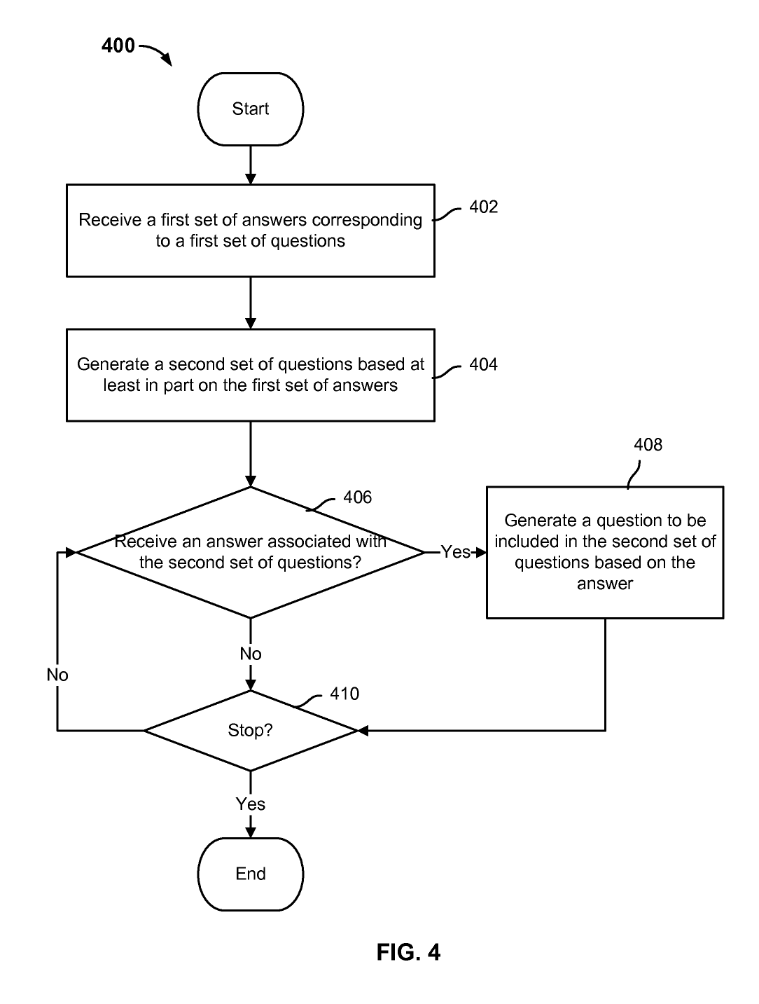

In some embodiments, the answers received for the second set of questions may be used to iteratively generate more questions to be included in the second set of questions, as will be further described with FIG. 4.

FIG. 4 is a flow diagram showing an embodiment of a process for generating questions. In some embodiments, process 400 is implemented at system 100.

Process 400 is used to illustrate that the answers received with respect to secondary questions may be iteratively used to generate more secondary questions.

At 402, a first set of answers corresponding to a first set of questions is received. In some embodiments, the first set of answers may comprise a set of seed questions. The seed questions may be presented to one or more users and the answers submitted by the users are received.

At 404, a second set of questions is generated based at least in part on the first set of answers. In some embodiments, the second set of questions based on the first set of answers may comprise secondary questions.

At 406, it is determined whether an answer associated with the second set of questions has been received. In some embodiments, at least some of the answers received for presented secondary questions are used to generate more secondary questions. For example, a secondary question generated based on an answer from another secondary question may seek yet another user's agreement or disagreement with the user's opinion included in the answer. In the event that an answer associated with the second set of questions has been received, then control passes to 408. Otherwise, control passes to 410.

At 410, it is determined whether the process is to stop. For example, if it is determined that the iterative process of generating more secondary questions based on answers received from existing secondary questions is to end, then the process ends. In the event that it is determined that the iterative question generation process is to continue, then control returns to 406.

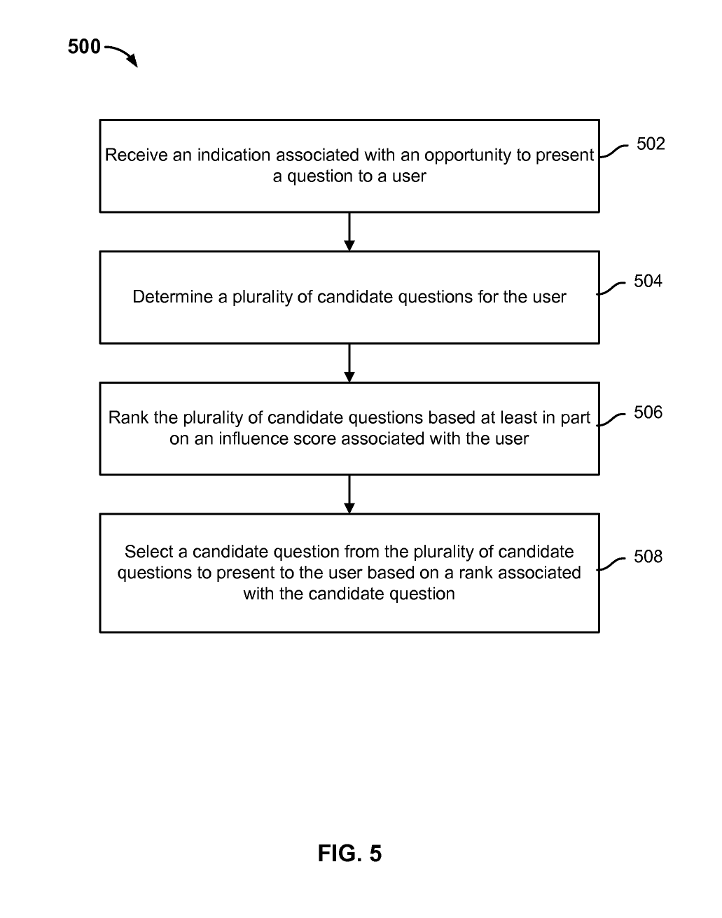

FIG. 5 is a flow diagram showing an embodiment of a process for selecting a question to present to a user. In some embodiments, process 500 is implemented at system 100.

At 502, an indication associated with an opportunity to present a question to a user is received. For example, when a user opens on a device the application associated with the question generation and presentation service, an indication associated with an opportunity to present a question to the user is received.

At 504, a plurality of candidate questions for the user is determined. For example, candidate questions include at least questions that have not been previously presented and/or answered by the user.

At 506, the plurality of candidate questions is ranked based at least in part on an influence score associated with the user. In some embodiments, a weight is computed for each candidate question, where the weight is determined based at least in part on an influence score associated with the user. For example, the influence score used to compute the weight for a particular candidate question may be the user's current influence score associated with the category of questions to which the question belongs. Other factors in addition to the user's influence score may be used in computing the weight of a candidate question. Once a weight has been computed for each candidate question, the candidate questions are ranked based on their respective weights. Because, in some embodiments, a user's influence score may change over time, each time a question is to be presented to a user, the weights of candidate questions may need to be computed again.

At 508, a candidate question from the plurality of candidate questions is selected to present to the user based on a rank associated with the candidate question. In some embodiments, the candidate question with the greatest weight, and therefore is ranked the highest, is selected to be presented to the user. Determining a question to present to a user based on an influence score associated with the user may cause the user to be presented with more questions from categories in which the user is more influential (i.e., categories in which the user has higher influence scores). As such, a user is given the chance to continually increase his or her influence in a particular category.

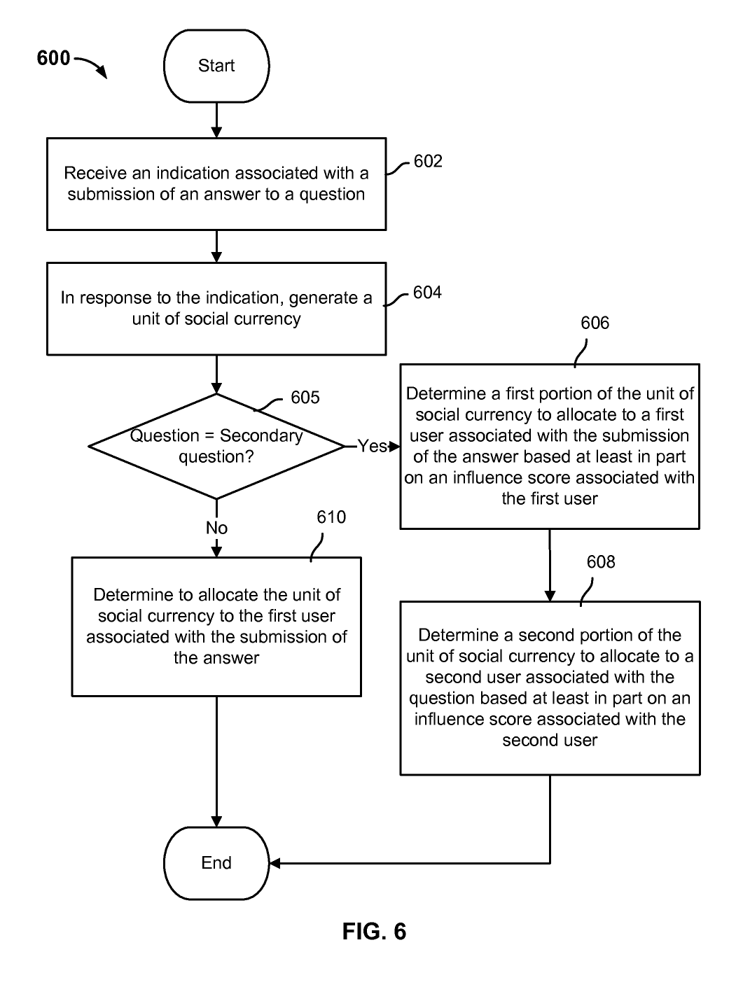

FIG. 6 is a flow diagram showing an embodiment of a process for allocating social currency for a submission of an answer to a question. In some embodiments, process 600 is implemented at system 100.

At 602, an indication associated with a submission of an answer to a question is received.

At 604, in response to the indication, a unit of social currency is generated. For each question that is answered, a unit of social currency is generated and allocated to one or more users.

At 605, it is determined if the question comprises a secondary question. In the event that the question comprises a secondary question, then the control passes to 606. If it is determined that the answered question was a secondary question, which is a question that is based on a previously submitted answer to another question, then control passes to 606. Otherwise, control passes to 610. At 610, if the answered question was a seed question, which was not based on an answer from another question, then the entire unit of social currency is determined to be allocated to the user associated with the submission of the question.

At 606, a first portion of the unit of social currency is determined to be allocated to a first user associated with the submission of the answer based at least in part on an influence score associated with the first user. In various embodiments, a secondary question is associated with at least two users: the first user may comprise the user who answered the question and the second user may comprise the user whose opinion (that was taken from a previously submitted answer) is included in the question.

At 608, a second portion of the unit of social currency is determined to be allocated to a second user associated with the question based at least in part on an influence score associated with the second user.

In some embodiments, the unit of social currency generated in response to the submission of an answer to the secondary question is divided between the two users based on the users' respective influence scores with respect to the category of the answered question.

For example, user Nancy45 answered a seed question that asked her which type of fabric is popular this winter with the answer choice “velvet”. Nancy45's influence score in the clothing category to which the seed question belongs is 150. Because Nancy45 had answered the seed question, Nancy45 was awarded a unit of social currency. Subsequently, a secondary question that asked user Jeff00 if he agreed with Nancy45's opinion that “velvet” was a popular fabric this winter. Jeff00's influence score in the clothing category to which the secondary question belongs is 50. Jeff00 submits an answer to the secondary question that he agreed with Nancy45's opinion that “velvet” was a popular fabric this winter. Because Jeff00 had answered the secondary question that involved Nancy45, a unit of social currency is to be divided between Jeff00 and Nancy45. For example, the unit of social currency may be divided proportionally based on the relative influence scores of users Jeff00 and Nancy45. For example, each user may be allocated the portion of the unit of social currency that is proportional to his or her share of the sum of the two users' influence scores. So Nancy45 would receive (150)/(150+50)*1.0=0.75 social currency units and Jeff00 would receive (50)/(150+50)*1.0=0.25 social currency units. As shown in this example, even though Nancy45 did not answer this particular question, because Nancy45's opinion was included in the question, Nancy45 was able to receive a portion of the unit of social currency that was generated from Jeff00's submission of an answer to this question. Furthermore, in some embodiments, because Jeff00 had agreed with Nancy45's opinion in his answer to this question, Nancy45 would enjoy an increase to her influence score in the clothing category. However, if Jeff00 had disagreed with Nancy45's opinion in his answer to this question, Nancy45 would have suffered a reduction to her influence score in the clothing category. In some embodiments, multiple user opinions may be included in a question to another user. For example, Jeff00 could have disagreed with Nancy45's opinion and instead agreed with another user's opinion that was included in the question. For example, the question could have asked Jeff00 whether he agrees with Nancy45's opinion that “velvet” is a popular fabric this winter or Sarah19's opinion that “leather” is a popular fabric this winter, in which case if Jeff00 agrees with Sarah19 then the unit of social currency could have been divided between Jeff00 and Sarah19 (e.g., based on their respective influence scores). As described above, in some embodiments, only the user whose opinion was agreed with in the question splits the unit of social currency with the user that answered the question. In some other embodiments, regardless of whose opinion the user that answered the secondary question agrees with, a unit of social currency is split among each user whose opinion was included in the question and the user who had answered the secondary question.

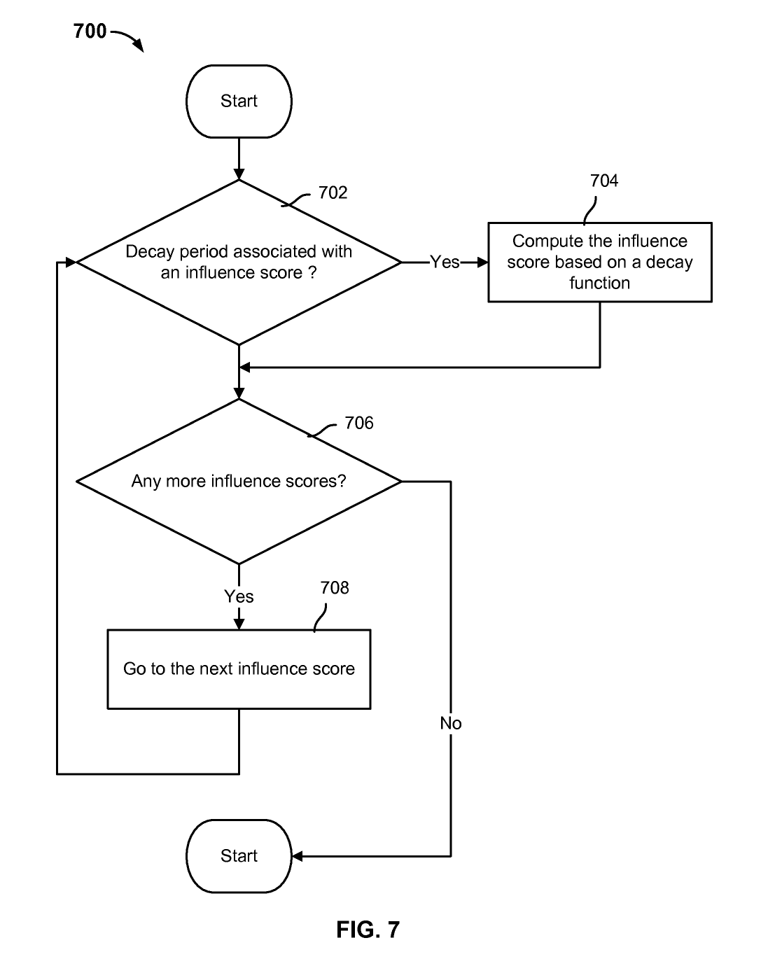

FIG. 7 is a flow diagram showing an embodiment of a process for decaying influence scores over time. In some embodiments, process 700 is implemented at system 100.

At 702, it is determined whether a decay period associated with an influence score has elapsed. In some embodiments, a decay period comprising a length of time may be configured such that per an elapse of each decay period for a particular influence score associated with a user, the influence score is to be decayed (i.e., reduced). For example, a timer may be associated with each influence score that tracks the length of time passed since the last time the influence score has been decayed. In the event that the decay period has elapsed for a particular influence score, then control passes to 704. Otherwise, control passes to 706.

At 704, the influence score is computed based on a decay function (e.g., an exponential decay function whose decay rate is empirically chosen by the administrator). The particular influence score whose decay period has elapsed is reduced. In some embodiments, an amount of reduction associated with the decay per each decay period is also configurable. For example, once an influence score has been computed based on the decay function, the timer associated with the influence score may be reset to zero.

At 706, it is determined whether there are any more influence scores to determine for decay. For example, another influence score of the same user or an influence score of another user may be checked for whether its associated decay period has elapsed. In the event that there is at least one more additional influence score to potentially decay, then control passes to 708. Otherwise, the process ends.

At 708, the next influence score is determined for decay.

Process 700 shows that an influence score of a user may decay over time. In combination with process 300 and other embodiments described above, it shows that for a user whose opinions are either not agreed with by other users and/or not often agreed with by other users, the user's influence scores (i.e., influence) with respect to the categories associated with such opinions will decrease. Thus, the user has an interest to generate more opinions (e.g., answer more questions) and especially ones that other users may agree with to maintain and even increase his or her influence level.

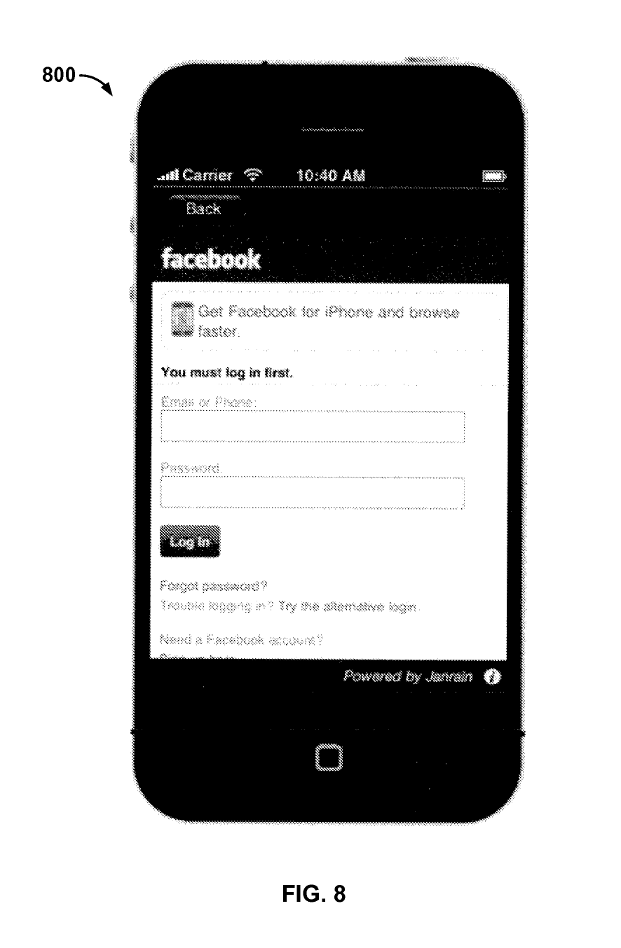

FIG. 8 is a diagram showing an example of an authentication user interface associated with the question generation and presentation service. In the example, user interface 800 is presented at a smart phone that is used by a user. In some embodiments, the user may gain authentication to use the question generation and presentation service using a third party authentication scheme such as Facebook® Connect. In the user interface of the example shown, Facebook® Connect is used to authenticate a user so the user may access the question generation and presentation service by submitting his or her Facebook® related email or phone and password in order to authenticate into the user's account with the question generation and presentation service. Other authentication techniques besides Facebook® Connect may be used as well.

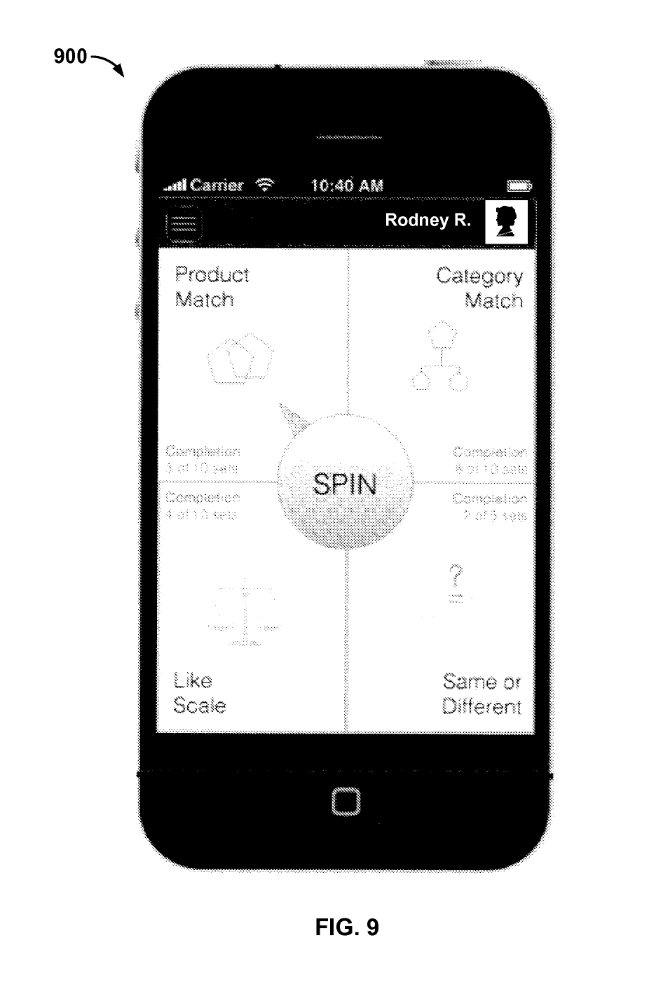

FIG. 9 is a diagram showing an example of a question type selection user interface associated with the question generation and presentation service. In the example, user interface 900 is presented at a smart phone that is used by a user. For example, user interface 900 may be presented to user Rodney R. after the user authenticated himself with the service using user interface 800 of FIG. 8. In the example, user interface 900 includes four different types of questions that may be presented to the user. The four types of questions included in the example include product match, category match, like scale, and same or different. In the example, the user may either directly select a particular question type (e.g., by tapping on the appropriate area of the screen) or select the “Spin” wheel to have a type of question be randomly selected for the user. Once the type of question is selected, a user may be presented with at least one question of the selected type.

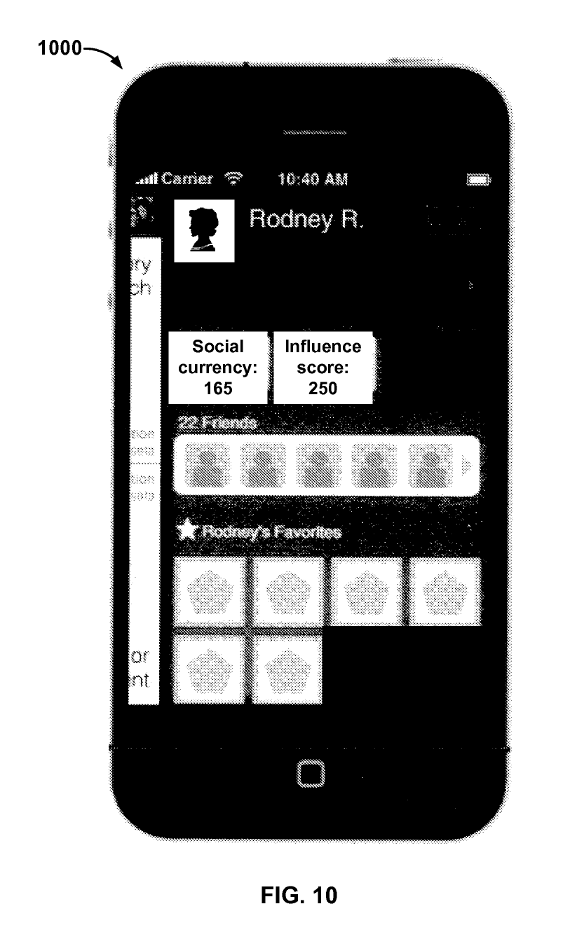

FIG. 10 is a diagram showing an example of a user profile user interface associated with the question generation and presentation service. In the example, user interface 1000 is presented at a smart phone that is used by a user. The user profile depicted in user interface 1000 is for user Rodney R. As shown in the example, the user profile shows the amount of social currency (165) that has been accumulated by Rodney R. and also a current influence score (250) associated with Rodney R. For example, the influence score may be across multiple categories of questions or associated with a particular category of questions. The user profile also shows the number of friends that Rodney R. has within the question generation and presentation user community, as well as Rodney R.'s favorite items (e.g., presented questions) within the question generation and presentation service.

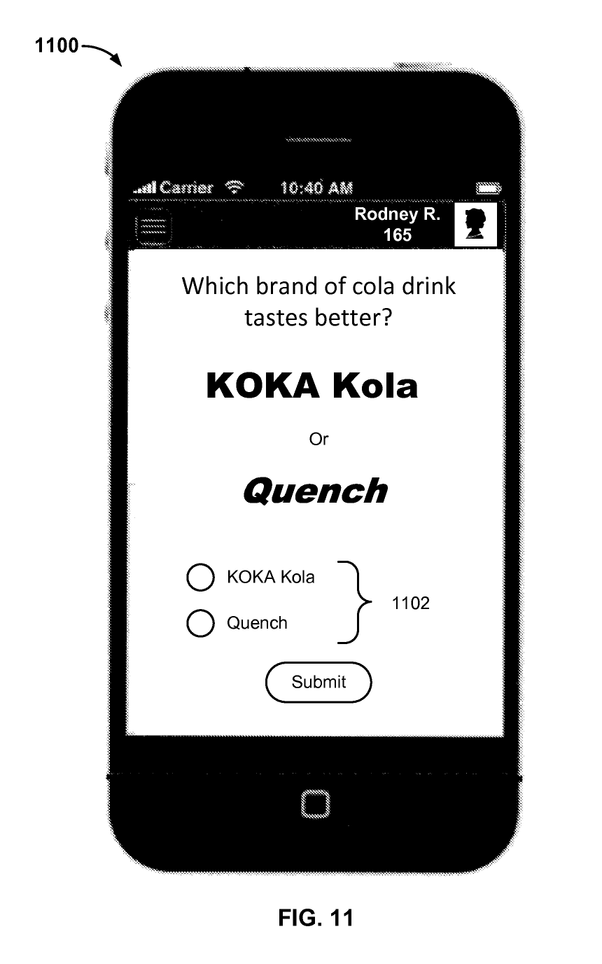

FIG. 11 is a diagram showing an example of a user interface associated with a presentation of a seed question. In the example, user interface 1100 is presented at a smart phone that is used by a user. At the upper right corner of user interface 1100 is information associated the user that is currently signed into the question generation and presentation service at the device. The user information indicates that the user is Rodney R. and that he has accumulated 165 social currency units so far. The seed question presented at user interface 1100 shows a question that asks the user of his opinion of whether “KOKA Kola” brand cola or “Quench” brand cola tastes better. The user may select the radio button associated with the brand of cola that the user thinks tastes better at the answer choices presented in area 1102. To submit the selected answer, the user may select the “Submit” button. In response to Rodney R.'s submission of an answer to the seed question, Rodney R would be awarded one social currency unit so that he would have accumulated 166 social currency units.

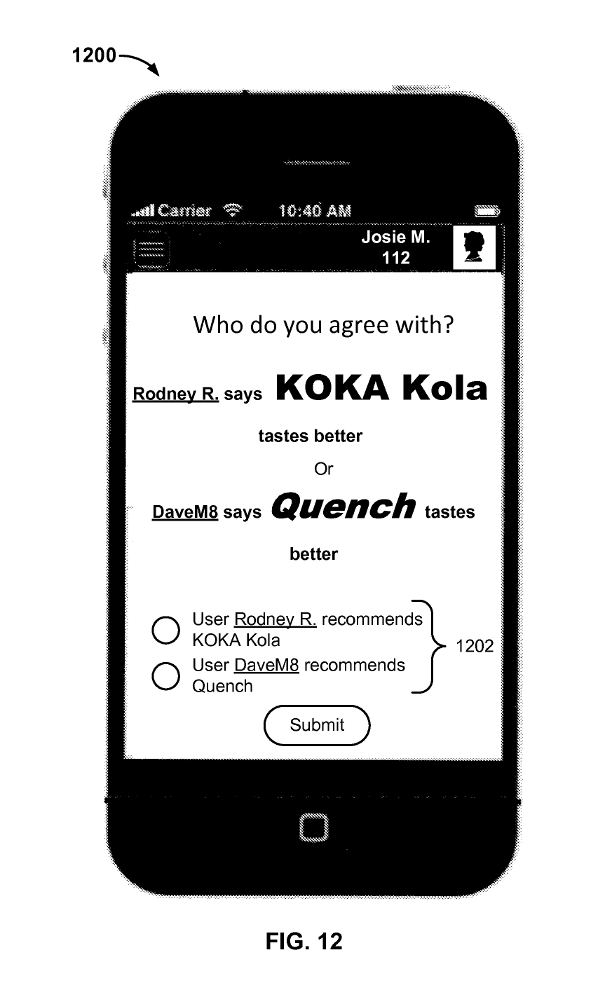

FIG. 12 is a diagram showing an example of a user interface associated with a presentation of a secondary question. In the example, user interface 1200 is presented at a smart phone that is used by a user. At the upper right corner of user interface 1200 is information associated the user that is currently signed into the question generation and presentation service at the device. The user information indicates that the user is Josie M. and that she has accumulated 112 social currency units so far. The secondary question presented at user interface 1200 shows a question that asks the user whether the user agrees with user Rodney R.'s opinion that “KOKA Kola” brand cola tastes better or agrees with user DaveM8's opinion that “Quench” brand cola tastes better. For example, at user interface 1100, Rodney R. submitted the answer that “KOKA Kola” brand cola tastes better and that answer (opinion) was used to generate the secondary question presented at user interface 1200. In the example, the user may select the radio button associated with the opinion that the user agrees with at the answer choices presented in area 1202. To submit the selected answer, the user may select the “Submit” button. In some embodiments, in response to Josie M.'s submission of an answer to the secondary question, a portion of a generated social currency unit is allocated to Josie M. for completing the question and another portion of the social currency unit may be allocated to Rodney R. for being included in the question. For example, if Josie M.'s answer had agreed with Rodney R.'s opinion that “KOKA Kola” tasted better, then both Josie M. and Rodney R. would receive portions of the social currency unit. However, if Josie M.'s answer had agreed with DaveM8's opinion that “Quench” tasted better, then both Josie M. and DaveM8 would receive portions of the social currency unit. Furthermore, if Josie M.'s answer had agreed with Rodney R.'s opinion that “KOKA Kola” tasted better, then Rodney R. would receive an increase to his influence score with respect to the category this question belongs to and DaveM8 would receive a reduction in his influence score in the same category. But if Josie M.'s answer had agreed with DaveM8's opinion that “Quench” tasted better, then DaveM8 would receive an increase to his influence score with respect to the category this question belongs to and Rodney R. would receive a reduction in his influence score in the same category.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A system to generate and present questions, comprising:
one or more processors configured to:
present a first set of questions to a plurality of users;
collect a first set of answers pertaining to the first set of questions;
generate a second set of questions pertaining to the first set of answers by the plurality of users; and
determine influence scores corresponding to the plurality of users based at least in part on a second set of answers pertaining to the second set of questions; and
one or more memories coupled to the one or more processors and configured to provide instructions.

2. The system of claim 1, wherein at least one question of the first set of questions comprises an inquiry for a user opinion.

3. The system of claim 1, wherein a question from the second set of questions is generated is based at least in part on at least one answer of the first set of answers.

4. The system of claim 1, wherein at least one question of the second set of questions comprises an inquiry for a user opinion of another user opinion.

5. The system of claim 1, wherein the one or more processors are further configured to generate one or more units of social currency in response to the first set of answers.

6. The system of claim 1, wherein presenting a first set of questions to a plurality of users includes:
receiving an indication associated with an opportunity to present a question to a user from the plurality of users;
determining a plurality of candidate questions for the user;
ranking the plurality of candidate questions based at least in part on an influence score associated with the user; and
selecting a candidate question from the plurality of candidate questions to present to the user based at least in part on a rank associated with the candidate question.

7. The system of claim 1, wherein collecting the first set of answers pertaining to the first set of questions includes:
receiving an indication associated with a submission of an answer to a question from the first set of questions;
determining that the question comprises a seed question; and
allocating a unit of social currency to a user from the plurality of users associated with the submission of the answer.

8. The system of claim 1, wherein the one or more processors are further configured to collect the second set of answers pertaining to the second set of questions including:
receiving an indication associated with a submission of an answer from a first user from the plurality of users to a question from the second set of questions;
determining that the question comprises a secondary question that is determined based at least in part on the answer submitted by a second user of the plurality of users;
determining a first portion of a unit of social currency to allocate to the first user associated with the submission of the answer based at least in part on an influence score associated with the first user; and
determining a second portion of the unit of social currency to allocate to the second user associated with the question based at least in part on an influence score associated with the second user.

9. The system of claim 1, wherein the one or more processors are further configured to reduce an influence score associated with a user based at least in part on a configured decay function.

10. The system of claim 1, wherein determining influence scores corresponding to the plurality of users based at least in part on the second set of answers pertaining to the second set of questions includes:
determining whether a first answer included in the second set of answers included an user agreement with a second answer included in the first of answers; and
in the event that the first answer agreed with the second answer, then adding at least one influence point to an influence score of a user associated with the second answer;
in the event that the first answer did not agree with the second answer, then reducing at least one influence point from the influence score of the user associated with the second answer.

11. A method for generating and presenting questions, comprising:
presenting a first set of questions to a plurality of users;
collecting a first set of answers pertaining to the first set of questions;
generating a second set of questions pertaining to the first set of answers by the plurality of users; and
determining influence scores corresponding to the plurality of users based at least in part on a second set of answers pertaining to the second set of questions.

12. The method of claim 11, wherein at least one question of the first set of questions comprises an inquiry for a user opinion.

13. The method of claim 11, wherein a question from the second set of questions is generated based at least in part on at least one answer of the first set of answers.

14. The method of claim 11, wherein at least one question of the second set of questions comprises an inquiry for a user opinion of another user opinion.

15. The method of claim 11, further comprising generating one or more units of social currency in response to the first set of answers.

16. The method of claim 11, wherein presenting a first set of questions to a plurality of users includes:
receiving an indication associated with an opportunity to present a question to a user from the plurality of users;
determining a plurality of candidate questions for the user;
ranking the plurality of candidate questions based at least in part on an influence score associated with the user; and
selecting a candidate question from the plurality of candidate questions to present to the user based at least in part on a rank associated with the candidate question.

17. The method of claim 11, wherein collecting the first set of answers pertaining to the first set of questions includes:
receiving an indication associated with a submission of an answer to a question from the first set of questions;
determining that the question comprises a seed question; and
allocating a unit of social currency to a user from the plurality of users associated with the submission of the answer.

18. The method of claim 11, further comprising collecting the second set of answers pertaining to the second set of questions including:
receiving an indication associated with a submission of an answer from a first user from the plurality of users to a question from the second set of questions;
determining that the question comprises a secondary question that is determined based at least in part on the answer submitted by a second user of the plurality of users;
determining a first portion of a unit of social currency to allocate to the first user associated with the submission of the answer based at least in part on an influence score associated with the first user; and
determining a second portion of the unit of social currency to allocate to the second user associated with the question based at least in part on an influence score associated with the second user.

19. The method of claim 11, further comprising reducing an influence score associated with a user based at least in part on a configured decay function.

20. The method of claim 11, wherein determining influence scores corresponding to the plurality of users based at least in part on the second set of answers pertaining to the second set of questions includes:
determining whether a first answer included in the second set of answers included an user agreement with a second answer included in the first of answers; and
in the event that the first answer agreed with the second answer, then adding at least one influence point to an influence score of a user associated with the second answer;
in the event that the first answer did not agree with the second answer, then reducing at least one influence point from the influence score of the user associated with the second answer.

21. A computer program product for generating and presenting questions, the computer program product being embodied in a computer readable storage medium and comprising computer instructions for:
presenting a first set of questions to a plurality of users;
collecting a first set of answers pertaining to the first set of questions;
generating a second set of questions pertaining to the first set of answers by the plurality of users; and
determining influence scores corresponding to the plurality of users based at least in part on a second set of answers pertaining to the second set of questions.
